(19) United States
(12) Patent Application Publication
(10) Pub. No.: US 2015/0224757 A1
(43) Pub. Date: Aug. 13, 2015

(54) METHOD FOR PRODUCING A RAISED SEAM

(71) Applicant: FORD GLOBAL TECHNOLOGIES, LLC, Dearborn, MI (US)

(72) Inventors: Jörg Sassmannshausen, Leverkusen (DE); Joerg Frietsch, Hennef (DE)

(21) Appl. No.: 14/425,768

(22) PCT Filed: Sep. 4, 2013
(86) PCT No.: PCT/EP2013/068283

§ 371 Date: Mar. 4, 2015

(30) Foreign Application Priority Data
Sep. 5, 2012 (DE) 10 2012 215 715.8
Oct. 1, 2012 (DE) 10 2012 217 959.3

(51) Int. Cl. B32B 38/00; F16B 11/00; B32B 37/00; B32B 37/24; B32B 37/12

(52) U.S. Cl. CPC B32B 38/0012; B32B 37/24; B32B 37/1292; B32B 37/1207; B32B 37/0076; B32B 38/0036; F16B 11/006; F16B 11/002; B32B 2038/0088; B32B 2037/243; B32B 2307/752; B32B 2605/08

(57) ABSTRACT

A method is provided for producing a double-flanged seam between an inner component having a free edge section and an outer component having a fold flange arranged on an edge section, comprising at least the following steps:
applying a structural adhesive, which expands under heat, in the form of an adhesive strip to one of the components on the side thereof oriented toward the other component,
crimping over the fold flange toward the inner component, thus creating a fold gap,
applying a paint coating, at least in the region of the double-flanged seam to one or both of the components, and
heating up at least the region of the double-flanged seam, thus melting and expanding the structural adhesive of the adhesive strip, which stretches in the process and thereby partially at least partially covers the paint coating in the region of the double-flanged seam.

The present invention relates to a method for producing a double-flanged seam between an inner component having a free edge section and an outer component having a fold flange arranged on an edge section.

DE 10 2008 060 930 A1 is concerned with a combined folded and adhesive joint on a body part of a motor vehicle, wherein an outer part of the body part is folded in a peripheral region about a peripheral region of an inner part of the body part, wherein an adhesive surrounds the peripheral region of the inner part on both sides. The production of the folded and adhesive joint is intended to be simplified if the adhesive is formed by a strip adhesive which can be shaped at least during the production of the folded and adhesive joint.

Double-flanged seams, which can also be referred to as folded seams, are used for connecting an inner panel to an outer panel. The two components here are designed to be connected to each other by bending the fold flange on the outer panel around the free edge section of the inner component. However, it is difficult to protect the double-flanged seam from corrosive exposure since moisture can accumulate in the folded seam, i.e. moisture permanently remaining in the folded seam, the moisture having an accelerating effect on the corrosive process. Also, it is known that, in the event of a merely frictional metal on metal contact, the double-flanged seam does not have the required strength properties, as required, for example, in vehicle manufacturing. Double-flanged seams are used, for example, on hoods, doors or the like. It is known therefore to provide the fold gap with suitable means in order to avoid the formation of corrosion and in order to be able to make the joint more resistant as a whole.

For this purpose, use is made, for example, of adhesives, as disclosed, for example, in WO 94/21740. WO 91/21740 is based on a method for achieving an adhesive joint in a folded seam between an inner part and an outer part using a cold epoxy adhesive applied to the surface of the edge region of the outer part, which surface is in contact with the edge region of the inner part. The two parts are brought one onto the other, with the fold flange being bent over. After the folded seam is completed, the adhesive strip is applied and pressed around the joint, but the adhesive does not cover the entire double-flanged seam. Therefore, an air bubble may be trapped in the double-flanged seam, this being intended to be prevented by the teaching of WO 94/21740 by an adhesive strip being applied in a hot phase before the two components are brought together and also before the folding. Air bubbles can therefore probably be avoided. However, the hot and liquid adhesive is pressed out of the folded seam during the folding-over operation, and therefore the adhesive can form drops which, when they drip off, may result in soiling of the assembly line and of tools in the following assembly stations.

In order to avoid such soiling, provision is intended to be made for the adhesive to cure before further processing of the component. However, this has a disadvantageous effect on the production cycle and is also complicated and unprofitable from an industrial management aspect.

EP 0 892 180 A1 proposes surrounding the inner component, around the free edge section thereof, with a preshaped adhesive body. The adhesive body is of U-shaped design in such a manner that it is kept attached to the free edge section by clamping force. A double-sided adhesive strip can optionally also be applied to the longer of the two U limbs such that an adhesive force can act in addition to the clamping force. If the adhesive body is fitted, the two components are brought together, with the double-flanged seam being completed by bending over the fold flange. The adhesive body is then softened such that the components are wetted at the point of adhesion. The point of adhesion is then cured.

DE 36 21 758 discloses a method for sealing a folded joint by means of a double-flanged seam adhesive, which is gellable and/or curable by a supply of heat, in the fold gap and by means of a sealing layer which is connected upstream of said fold gap, consists of a material which is gellable and/or curable by a supply of heat, and is applied to the cut edge of the folded joint, wherein the folded joint is subjected to at least one heat treatment. At least the double-flanged seam is heated to the curing temperature, with the sealing layer being applied to the heated cut edge.

Accordingly, the production of a double-flanged seam with a pasty adhesive is a critical process in respect of corrosion protection, but also in respect of the filling, as intended, of the double-flanged seam by means of the adhesive. In addition, provision is made for the adhesive to be subject to preliminary curing, with individual weld points also being provided in order to prevent a relative movement of the two components to be connected. Up until now, a filling rate of 100/100/>0 can be achieved only by squeezing the adhesive out of the double-flanged seam, and this involves a considerable outlay on cleaning, as already indicated above with regard to WO 94/21740. The joint can be inspected by an inspection similar to a statistical process control (SPC), but non-destructive inspection methods for verifying whether the double-flanged seam is correctly filled are still not adequately used.

Against this background, it is the object of the present invention to indicate a method for producing a double-flanged seam, with which it can be ensured that the double-flanged seam is protected against corrosion, wherein inadvertent trapping of air can be eliminated and wherein the use of an additional edge sealing can be dispensed with.

This object is achieved by a method with the features of claim 1. The dependent claims disclose further, particularly advantageous refinements of the invention.

It should be emphasized that the features cited individually in the description below can be combined with one another in any technically expedient manner and indicate further refinements of the invention. The description characterizes and specifies the invention, in particular, additionally in conjunction with the figures.

According to the invention, a method for producing a double-flanged seam between an inner component having a free edge section and an outer component having a fold flange arranged on an edge section comprises the following steps:
applying a structural adhesive, which expands under heat, in the form of an adhesive strip to one of the components on the side thereof oriented toward the other component,
crimping over the fold flange toward the inner component, thus creating a fold gap,
applying a paint coating, at least in the region of the double-flanged seam, to one or both components, and
heating up at least the region of the double-flanged seam, thus melting and expanding the structural adhesive of the adhesive strip, which stretches in the process and thereby at least partially covers the paint coating in the region of the double-flanged seam.

The invention achieves a double-flanged seam which is protected against corrosion and which, in addition thereto, is sealed without additional use of a special sealing substance at the relevant points thereof by a sealing bead which covers the paint coating being formed by expansion and stretching of the structural adhesive.

In an advantageous refinement, the adhesive strip has, at least in sections, an extension which is adapted to a subsequent fold gap and which, at least at one end of the fold gap, is shorter than the extension of the fold gap.

It is possible that the adhesive strip is a prefabricated adhesive element. In an advantageous embodiment, the structural adhesive strip is stuck onto one of the components, wherein a fastening section and a protrusion are formed. In a preferred refinement, the protrusion is dimensioned in such a manner that, after bending around the free edge of the inner component, said protrusion is shorter than the fold flange in the bent-over state. In this respect, the structural adhesive strip has an extension, i.e. a width, which is shorter than the extension of the fold gap.

It is expedient if the adhesive strip consists of a pasty structural adhesive and is sprayed onto at least one component.

As already mentioned above, it is advantageous in the context of the invention if the sealing bead is formed on expansion and stretching of the structural adhesive, said sealing bead being placed, as it were, onto the paint coating and thus also protecting the free cut edges, wherein the sealing bead settles into an intermediate space between the inner component and the outer component, thereby in particular bridging a transition of a free edge section of the inner component.

In order to be able to achieve as simple an application of the structural adhesive as possible and uniform contact thereof, it can advantageously be provided that the adhesive strip slightly heats up without expanding during application to a component, wherein the structural adhesive is therefore preferably heated up at such a low temperature so as to be free from expansion and stretching. It is expedient here if the adhesive strip cools down after application before crimping over the fold flange. Thus, despite application in the heated-up state, squeezing of the structural adhesive out of the fold gap can advantageously be avoided. It can also be advantageous for the adhesive strip to at least partially cure after having been applied to the relevant component and before crimping over the fold flange. With these measures, the squeezing-out effect, which is in any case avoided by the invention, can be further eliminated.

In a further advantageous refinement, the adhesive strip can comprise finely dispersed spacers, particularly in the form of glass beads. The spacers can define a defined distance between the two body parts such that the two components, in particular after the crimping, are at a homogeneous distance at least in the region of the fold gap. A homogeneous distance between the two components can be considered to be advantageous to the effect that the fold gap is likewise filled homogeneously. In this respect, provision can expediently be made for the spacers to have dimensions within the range of the width of the fold gap. The spacers may have different geometrical configurations, wherein the spacers in an adhesive strip are preferably to have the same geometrical configuration. Such spacers can be designed, for example, as tetrahedrons, as spheres, as cubes or as octahedrons, to mention just a few non-limiting configurations. The dimensions of the spacers are, of course, variable, but are preferably directly dependent on the double-flanged seam to be produced. In particular, the spacers can ensure a minimum volume in order to be able to achieve controlled expansion of the adhesive strip. Of course, the material of the spacers is not limited to the material glass. By way of example, the spacers may also consist of a ceramic or of raw mineral materials. The geometrical spacers thus also serve to ensure uniform flange geometries after the bending-over operation.

In a preferred embodiment, the paint coating is a corrosion protection primer.

In a possible refinement, the structural adhesive strip is applied to the inner component in such a manner that the fastening section adheres to the inner component. The excess length protrudes over the free edge of the inner component.

In a preferred embodiment, the adhesive side of the excess length is free from the protection element.

If the structural adhesive strip is applied to the inner component, i.e. is bonded by the fastening section thereof to the inner component, the inner component and the outer component are brought or joined together. In this joining process, the excess length is already appropriately entrained or deformed such that the excess length is arranged, for example, parallel to the profile of the fold flange. Since the adhesive side does not have any contact with the fold flange, the structural adhesive strip correspondingly slides on the fold flange and is entrained without adhering. In this state, the structural adhesive strip bears with the structural side thereof opposite the adhesive side against the outer component, i.e. against the fold flange. The fold flange is subsequently crimped toward the inner component, thus forming the double-flanged seam, i.e. the folded seam. When the fold flange is folded, the excess length of the structural adhesive strip is correspondingly, i.e. inevitably, entrained, with the adhesive side bearing against the free edge, but also against the inner component. The free edge section of the inner component is therefore surrounded, as it were, in some regions by the structural adhesive strip.

If, by contrast, the structural adhesive strip is sprayed onto one of the components, an excess length or fastening section, as in the case of a prefabricated adhesive element which is adhesive on one side, is, of course, not formed, and the effective length of the structural adhesive strip is applied in such a manner that the corresponding expansion spaces are present after the mechanical bending-over step.

Before the double-flanged seam is heated up, the paint coating is applied after the fold flange has been bent over.

The double-flanged seam is produced in the cold state, wherein the structural adhesive strip is shorter in the cold state than the fold gap. The structural adhesive strip is arranged here with the inner, free edge thereof within the fold gap and is spaced apart from the transition of the free edge section to the inner component. The outer, free edge of the structural adhesive strip, which edge is opposite the inner, free edge, likewise resides within the fold gap, but spaced apart from the free edge of the fold flange. The expansion space for the structural adhesive strip is thus provided in each case when said structural adhesive strip is heated up on account of the action of heat in the double-flanged seam region. It is advantageous here that the structural adhesive forms the sealing bead on emerging from the fold gap, and therefore dripping of liquid or pasty adhesive is avoided. The sealing bead here is firstly placed around the entire free edge of the fold flange and secondly in the intermediate space between the outer component and the inner component, thereby bridging the transition of the free edge section of the inner component. It is advantageous that the structural adhesive strip here has more than one function. Firstly, a joint is provided between the inner and the outer component, said joint withstanding the corresponding demands in respect of corrosion protection and strength and similar mechanical demands, wherein secondly, the formation of the sealing bead makes it possible to dispense with a special and additional casing material or sealing material. During the heating-up operation, the structural adhesive strip expands, but not only so as to emerge from the fold gap, but also in such a manner that the entire fold gap is filled, with the trapping of a medium being avoided, wherein the two components are connected to each other by the adhesion of the structural adhesive strip. The respective paint coating is advantageously surrounded here by the sealing bead, and therefore the double-flanged seam is protected against penetrating moisture and extraneous materials.

In a further advantageous refinement of the method, provision can be made, in a first intermediate step before the two components are joined together, to form the excess length of the structural adhesive strip just in the direction of the free edge of the free edge section of the inner component such that the adhesive side adheres to the free edge. The two components can subsequently be drawn together, and the previously described steps can be carried out.

However, it is also possible, in a second intermediate step, to form the excess length completely around the free edge before the two components are joined together, and therefore the structural adhesive strip encloses the free edge section in some regions and adheres thereto. The two components can subsequently be joined together, wherein the fold flange is folded in the direction of the inner component. The application of the paint coating and the heating up follow.

In a preferred configuration, the structural adhesive strip can be applied to the corresponding component by means of a preferably stationary application head. Subsequently, the structural adhesive strip, in the form of an adhesive tape in the exemplary embodiment, is placed around the component edge by means of hot air nozzles, foam rollers or brushes, to mention just a few possible examples. The hot air softens and sufficiently sticks the structural adhesive strip to the metal surface, even if the latter is greasy, oily or covered in some other way. The structural adhesive strip is then first of all cooled, as has already been mentioned.

The preferably stationary application head for the structural adhesive strip permits the application of materials with a variable width and thickness. The application head can also have a cutting device for exact cutting to size of the structural adhesive strip to be used. However, the application head may also have the spraying device if the structural adhesive strip is sprayed on, with it being possible to dispense with a cutting device and/or laying devices.

The method according to the invention can be used for any form of bent-over flange joints and can be used for galvanized steel, non-galvanized steel, aluminum and also magnesium components without being restricted to the materials mentioned.

The complete curing of the structural adhesive strip can take place, for example, in an electro coating furnace, but curing can also take place by means of any heating-up method.

In a possible embodiment, the structural adhesive strip can be fastened by the fastening section thereof to that side of the free edge section of the inner component which is oriented toward the outer component, wherein the excess length is then deformed, i.e. is bent around the free edge, this being carried out at the latest together with the folding of the fold flange after the two components have been joined together. However, it is also possible first of all to fasten the excess length to the free edge section of the inner component on the side opposite the outer component and then to implement the bending operation around the free edge.

However, it is also conceivable for the structural adhesive strip to be placed by the adhesive side thereof onto the free edge of the free edge section of the inner component, wherein the structural adhesive strip is deformed by the protruding limbs thereof, i.e. by the excess length thereof and by the fastening section towards the free edge section, such that a structural element surrounding the free edge section of some regions likewise adheres to the free edge section.

In a further possible embodiment, provision can be made for the structural adhesive strip to be placed on that side of the outer component which is oriented toward the inner component, wherein the fold flange is partially covered by the excess length. The two components can be brought together, folded and the double-flanged seam produced with subsequent heating after the painting operation.

The structural adhesive strip, if the latter is not sprayed on, as already mentioned has just one adhesive side which is provided with the protection element removed before application. In a preferred refinement, the protection element is designed as a protection film, i.e. as a peel-off film, which can easily be peeled off from the adhesive side. It is particularly advantageous if the structural adhesive strip is designed as a hot-melt sealing tape which is adhesive on one side and which expands after heating and, thus filling the fold gap in all directions, has the required property.

The structural adhesive strip can be applied to the respective component piece by piece, i.e. in sections, as a strip of respectively adaptable length, which means that the respective piece of structural adhesive strip also only covers part of the component concerned, with the entire circumference being able to be covered by arranging a plurality of individual structural adhesive strips next to one another. In this respect, the structural adhesive strip can be produced as roll stock, wherein the appropriate length required in each case can be severed, which, of course, can take place in an automated manner. In a further possible refinement, it is possible to produce a structural adhesive strip which is adapted to the circumference of the components and can be applied in one piece to the component concerned. In this respect, the structural adhesive strip can be produced in the form of piece goods matched to the component concerned. The structural adhesive strip can have a thickness of 0.3 to 1 mm, but this, of course, is not intended to be limiting. The aim, however, in each case is for the width of the structural adhesive strip preferably to be dimensioned in such a manner that the fold gap is not completely filled in the cold state. Of course, the dimensions mentioned can also be used for the sprayed-on structural adhesive strip.

It is possible, for example, to produce a double-flanged seam for a vehicle door, wherein the outer and the inner components can therefore be door panels. Of course, the method according to the invention is not restricted to the production of double-flanged seams on vehicle doors, but rather includes all possible components which may have double-flanged seams.

The invention provides an improved method for producing a double-flanged seam, with which method preliminary curing can be avoided, and nevertheless no soiling due to dripping adhesive should be anticipated. In addition, the structural adhesive strip is relatively thick with respect to adhesive tapes or with respect to the thickness of applied pasty pastes, and therefore, during the folding of the fold flange, adequate mechanical strength can already be achieved between the two components, as a result of which preliminary curing and even weld points can be dispensed with, since a relative movement between the components to be connected can be avoided by the thickness of the structural adhesive strip and resulting mechanical stability. In addition, mechanical squeezing of material out of the fold gap during the folding operation is avoided. The structural adhesive strip can be applied automatically, for example, with a robot (application head), wherein, of course, the bringing together of the two components, but also the folding process and the painting and subsequent heating, can be automated. For example, owing to the automatic application possibility, safe and controlled fastening or application of the structural adhesive strip is possible, and this obviates the need for a subsequent inspection of a correct double-flanged seam, in particular under destructive conditions, since the same results corresponding to the requirements can always be achieved using verified method parameters. With the method, the use of additional sealing measures such as, for example, the application of a cosmetic sealing element or the application of water-repelling wax can be dispensed with. A particular advantage of the method according to the invention is that the paint coating is applied before the structural adhesive expands. The paint coating together with the elements to be protected can thus be encased by the structural adhesive, which is particularly beneficial as protection against corrosion.

Further advantageous details and effects of the invention are explained in more detail below with reference to exemplary embodiments which are illustrated in the figures, in which:

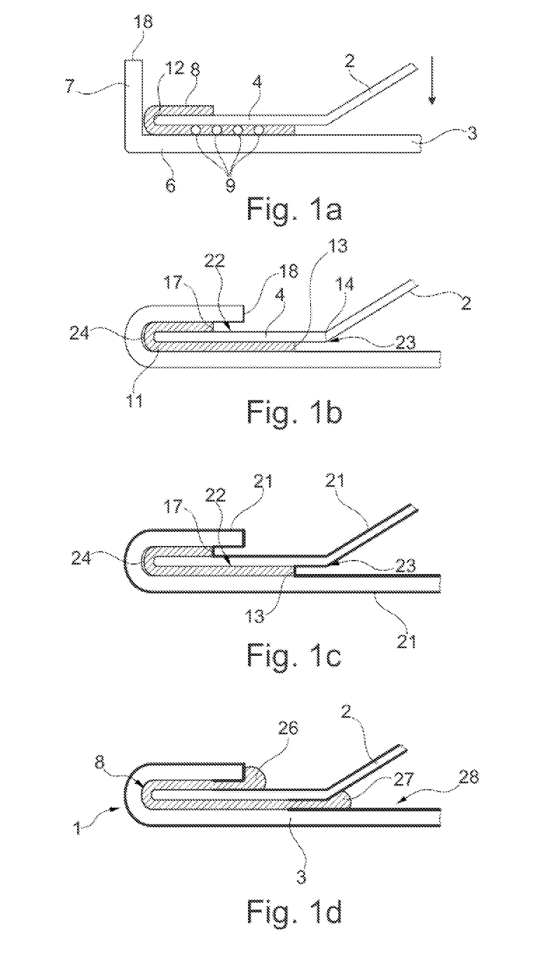

FIGS. 1a to 1d show a schematic sectional view with individual steps for producing a double-flanged seam, and

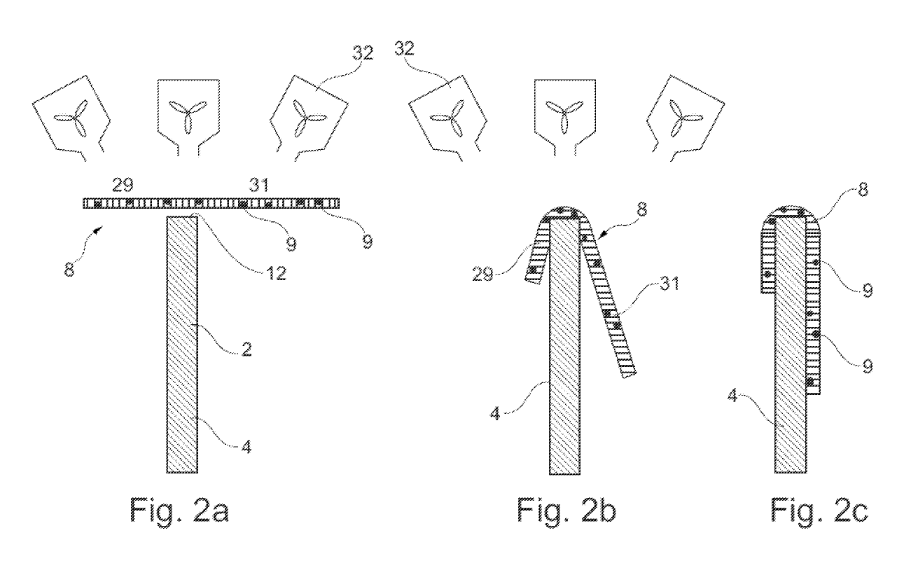

FIGS. 2a to 2c show an exemplary procedure for applying the structural adhesive strip to one of the components.

The same parts are always provided with the same reference numbers in the various figures, and therefore said parts will generally also only be described once.

FIGS. 1a to 1d show a method for producing a double-flanged seam 1 between an inner component 2 and an outer component 3. The inner component 2 is, for example, an inside door panel of a motor vehicle and has a free edge section 4 which, by way of example, is arranged at an angle to the inner component 2. The outer component 3 is, for example, an outside door panel of the motor vehicle and has a fold flange 7 arranged on an edge section 6.

First of all, a structural adhesive strip 8 which can have an adhesive side, i.e. can be adhesive on one side, is applied. The structural adhesive strip 8 may also be sprayed on. The structural adhesive strip 8 is produced with such an extension that the structural adhesive strip 8 is shorter than a fold gap 11 (FIG. 1b). The structural adhesive strip 8 therefore has a width shorter, i.e. narrower, than the extension of the entire fold gap 11. The structural adhesive strip 8 has spacers 9 which are illustrated schematically in FIG. 1a. The spacers 9 will be discussed in more detail further below.

The structural adhesive strip 8 is applied in such a manner that it surrounds an inner edge 12 of the inner component 2 such that the structural adhesive strip 8 is guided around the inner component 2 with an extension around the inner component 2 that is shorter than the fold gap 11. The fold flange 7 is subsequently folded towards the inner component 2 (FIG. 1b). The fold flange 7 here can be directly and completely crimped over, but a preliminary folding-over of, for example, 45° of the fold flange 7 towards the inner component 2 is also conceivable, and the complete crimping over is continued only after a possible visual examination.

The previous steps were carried out without the effect of heat, wherein it can be seen in FIG. 1b that the structural adhesive strip 8 is shorter in the cold state, i.e. is narrower, than the fold gap 11. The structural adhesive strip 8 here is arranged with the inner, free edge 13 thereof within the fold gap 11 and is spaced apart from a transition 14 of the free edge section 4 of the inner component 2, i.e. at the angle between the two. The outer, free edge 17 of the structural adhesive strip 8, which edge is opposite the inner edge 13, likewise resides within the fold gap 11, but spaced apart from the free edge 18 of the fold flange 7. Respective expansion spaces 22 and 23 are thereby formed.

If the structural adhesive strip 8 is supplied under the effect of heat without the structural adhesive strip 8 expanding, the latter is first of all cooled before the fold flange 7 is crimped over.

If the fold flange 7 is folded, i.e. the state according to FIG. 1b is reached, a paint coating 21 is applied (FIG. 1c). The paint coating 21 is preferably applied in such a manner that not only the region of the double-flanged seam 1, but also adjacent regions of the two components 2 and 3, are provided with the paint coating 21. The two components 2 and 3 are preferably completely provided with the paint coating 21, which is expedient if the latter is designed as a corrosion protection primer.

As can be seen in FIG. 1c, the paint coating 21 is likewise applied in the expansion spaces 22 and 23 of the fold gap 11 and is also placed onto the edges 13 and 17 of the structural adhesive strip 8. The structural adhesive strip 8 is thus housed, as it were, by the paint coating 21.

If the paint coating 21 is applied, at least the region of the double-flanged seam is subject to a heat treatment, i.e. is heated up. A heat treatment to be carried out in an electric furnace at, for example, 175° C. for a duration of, for example, 10 minutes, may be sufficient here for the structural adhesive strip 8 to be able to expand out of the fold gap 11 into the respective expansion space 22 and 23, but also in all other directions. For example, an air gap 24 which is filled after the heat treatment (FIG. 1d) can be seen in FIG. 1c. Of course, the values mentioned are mentioned merely by way of example and are in no way limiting.

FIG. 1d shows the state after the heat treatment. FIG. 1d shows that the structural adhesive strip 8, inter alia, has emerged from the fold gap 11 and in each case a sealing bead 26, 27 is formed, said sealing bead settling firstly around the entire free edge 18 of the fold flange 7 and secondly into the intermediate space 28 between the inner component 2 and the outer component 3, thereby bridging the transition 14 of the free edge section 4 of the inner component 2 and sealing the two components. In this respect, after heating, a filling rate of at least 100/100/A, in particular also of critical regions, such as, for example, corners, rounded portions and also design lines, can be achieved. Since the structural adhesive strip 8 does not initially completely fill the fold gap 11, but is arranged with the free edges 13 and 17 thereof merely at a small distance from the elements 14 and 18 concerned, even a filling rate of 100/100/100 can be seen in the figures after the expansion.

However, it can also be seen in FIG. 1d that the respective sealing bead 26, 27 also encases the paint coating 21 in the regions concerned.

By the paint coating 21 also being surrounded by the expanded structural adhesive strip 8, a particularly targeted sealing against penetrating moisture is ensured.

The structural adhesive strip 8 can be, for example, a hot-melt sealing tape which is adhesive on one side and is made from an acrylate-epoxy hybrid adhesive, or can be sprayed on as such.

All of the steps can be carried out in an automated manner, for example, by means of a robot. In a preferred embodiment, strips of in each case an adaptable length of the structural adhesive strip 8 are cut to size and applied to one of the two components 2, or in the manner described above. The aim here is that the structural adhesive strip 8 in the cold state has the width which is to be adapted in each case to the anticipated fold gap 11, and therefore the expansion spaces 22 and 23 are in each case formed, with it being possible for the structural adhesive strip to have a thickness of 0.3 to 1 mm.

As already mentioned above, the adhesive strip can have finely dispersed spacers 9, particularly in the form of glass beads. The spacers 9 can define a defined spacing between the two body parts 2, 3 and therefore the two components 2, 3 in particular after the crimping, are at a homogeneous distance at least in the region of the fold gap 11. A homogeneous distance between the two components 2, 3 can be conceded to be advantageous to the effect that the fold gap 11 can likewise be filled homogeneously. In this respect, provision can expediently be made for the spacers 9 to have dimensions within the range of the width of the fold gap. The spacers 9 can have different geometrical configurations, wherein the spacers 9 in one adhesive strip preferably are intended to have the same geometrical configuration. Such spacers 9 can be designed, for example, as tetrahedrons, as spheres, as cubes or as octahedrons, in order to mention just a few non-limiting configurations. Of course, the dimensions of the spacers 9 are variable, but preferably directly dependent on the double-flanged seam 1 to be produced. In particular, the spacers 9 can ensure a minimum volume in order to be able to achieve a controlled expansion of the adhesive strip 8. Of course, the material of the spacers 9 is also not restricted to the material glass. By way of example, the spacers 9 can also consist of a ceramic or of raw mineral materials. The geometrical spacers 9 thus also serve for ensuring uniform flange geometries after the bending-over operation.

FIGS. 2a to 2c illustrate a possible procedure as to how the structural adhesive strip is placed around the free edge section 4 of the inner component 2. The structural adhesive strip 8 is designed by way of example as a hot-melt sealing tape which is adhesive on one side.

The structural adhesive strip 8 is placed by the adhesive side thereof onto the free edge 12 of the free edge section 4, wherein the structural adhesive strip 8 is deformed by the protruding limbs 29 and 31 thereof, i.e. by the excess length 29 thereof and by the fastening section 31 thereof towards the free edge section 4 such that a structural adhesive strip 8 surrounding the free edge section in some regions adheres to the free edge section 4. In order to deform the structural adhesive strip 8 towards the free edge section 4, hot air nozzles 32 can be provided, by way of example. The hot air heats up the structural adhesive strip 8 at such a low temperature that deformation is possible, but expansion is prevented. If the structural adhesive strip 8 is placed around the free edge section 4 (FIG. 2c), the structural adhesive strip 8 is cooled, wherein cooling to room temperature is sufficient. The spacers 9 which may have entirely different dimensions, as can be seen in FIGS. 2a to FIG. 2c, can be seen in the structural adhesive strip 8.

### LIST OF REFERENCE NUMBERS

1 Double-flanged seam

2 Inner component

3 Outer component

4 Free edge section of 2

6 Edge section of 3

7 Fold flange

8 Structural adhesive strip

9 Spacer

11 Fold gap

12 Inner edge of 4

13 Inner, free edge of 8

14 Transition

17 Outer, free edge of 8

18 Free edge of 7

21 Paint coating

22 Expansion space

23 Expansion space

24 Air gap

26 Sealing bead

27 Sealing bead

28 Intermediate space

29 Excess length

31 Fastening section

32 Hot air nozzles

1. A method for producing a double-flanged seam between an inner component having a free edge section and an outer component having a fold flange arranged on an edge section, comprising at least the following steps:
applying a structural adhesive, which expands under heat, in the form of an adhesive strip to one of the components on the side thereof oriented toward the other component,
crimping over the fold flange toward the inner component, thus creating a fold gap,
applying a paint coating, at least in the region of the double-flanged seam to one or both of the components, and
heating up at least the region of the double-flanged seam, thus melting and expanding the structural adhesive of the adhesive strip, which stretches in the process and thereby at least partially covers the paint coating in the region of the double-flanged seam.

2. The method as claimed in claim 1,
characterized in that
the adhesive strip has, at least in sections, an extension which is adapted to a subsequent fold gap and which, at least at one end of the fold gap, is shorter than the extension of the fold gap.

3. The method as claimed in claim 1,
characterized in that
the adhesive strip is a prefabricated adhesive element.

4. The method as claimed in claim 1,
characterized in that
the adhesive strip consists of a pasty structural adhesive and is sprayed onto at least one component.

5. The method as claimed in claim 1,
characterized in that
a sealing bead is formed from the expanding structural adhesive at the end of the fold gap.

6. The method as claimed in claim 5,
characterized in that
the sealing bead settles into the intermediate space between the inner component and the outer component, thereby bridging the transition of the free edge section of the inner component.

7. The method as claimed in claim 1,
characterized in that
the adhesive strip slightly heats up without expanding during application to a component.

8. The method as claimed in claim 7,
characterized in that
the adhesive strip cools down after application before crimping over the fold flange.

9. The method as claimed in claim 1,
characterized in that
the adhesive strip at least partially cures after having been applied to the component and before crimping over the fold flange.

10. The method as claimed in claim 1,
characterized in that
the adhesive strip comprises finely dispersed spacers, particularly in the form of glass beads.

11. The method as claimed in claim 10,
characterized in that
the spacers have dimensions within the range of the width of the fold gap.

12. The method as claimed in claim 1,
characterized in that
the paint coating is a corrosion protection primer.
